(19) United States
(12) Patent Application Publication
(10) Pub. No.: US 2006/0021513 A1
(43) Pub. Date: Feb. 2, 2006

(54) Wine storage of ageing type

(75) Inventor: Hajime Ide, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Eddy Enterprise Co., Ltd., Tokyo (JP)

(21) Appl. No.: 10/519,989

(22) PCT Filed: Mar. 22, 2004
(86) PCT No.: PCT/JP04/03822

§ 371 Date: Jan. 4, 2005

(51) Int. Cl. C12G 1/02

(52) U.S. Cl. 99/277

(57) ABSTRACT

A wine storage apparatus (1) having a white wine storage compartment (4) and a red wine storage compartment (5) for keeping the compartment temperature at a constant level suitable for preserving white wine and red wine, and a wine aging storage compartment (3). The temperature of the storage compartment (3) is repeatedly raised and lowered by a control apparatus (30) in accordance with a fixed variation pattern in a temperature band from 10° C. to 22° C. in a one-year cycle. It was confirmed that ideal aging of the wine is promoted when wine is stored in the storage compartment (3).

### TECHNICAL FIELD

The present invention relates to a wine storage apparatus provided with a wine aging function.

### BACKGROUND ART

Wine cellars currently on the market are refrigerators provided with a function for preserving wine at a temperature and humidity set by the user. It is commonly believed that wine is ideally stored at a constant temperature of 13° C. to 14° C. and a constant humidity of about 65%. Therefore, a wine cellar is provided with a temperature control function to prevent the temperature in a compartment from departing from the set temperature, and the temperature is controlled so that the maximum band of fluctuation is 4° or less.

Apparatuses for cooling wine to an optimal drinking temperature of about 10° C. are also known as wine cellars. Wine cellars have also been proposed that are provided with both a storage compartment for storing wine over a long term at 13° C. to 14° C. and a storage compartment for cooling the wine to the optimal drinking temperature of about 10° C.

### DISCLOSURE OF THE INVENTION

Wine is aged by oxidation and reduction, and a suitable amount of oxygen is required. Oxygen required for aging is provided by air circulating through a cork that seals a mouth of a wine bottle.

However, there is no design in prior art for using a wine cellar or another storage area provided with a temperature control mechanism to age wine. The present inventor varied the temperature in the wine cellar according to different variation patterns to investigate the aged condition of wine, contradicting the widely held concept that the temperature of a wine cellar should be kept as constant as possible. As a result, it was discovered that aging by oxidation and reduction can be promoted and wine can be ideally aged without causing the wine to spoil and decline.

The present invention was contrived based on this novel idea, and an object thereof is to provide a wine storage apparatus that has an aging function.

In order to achieve the above-described object, a wine storage apparatus of the present invention has a wine storage compartment for storing wine, and
a temperature control device for controlling the temperature of the wine storage compartment,
wherein the temperature control device repeatedly raises and lowers the temperature in the compartment in accordance with a preset cycle, a preset temperature band, and a preset variation pattern.

Here, the shortest cycle is preferably four months, and in common practice the temperature is preferably varied with a cycle of one year.

The temperature band is preferably 4° or greater in a range from 8° C. to 25° C. Particularly preferred is a temperature band that is 8° C. or greater in a range from 10° C. to 22° C.

It is also preferable to adopt the variation pattern in which the temperature in the compartment is raised in a linear, curvilinear, or stepwise manner, and is lowered in a linear, curvilinear, or stepwise manner.

Next, the wine storage apparatus of the present invention preferably has, in addition to the temperature control device, a humidity control device for keeping the humidity of the wine storage compartment at a preset value. In general, the humidity of the wine storage compartment can be kept at about 65% by the humidity control device.

To allow a user to age the wine to the desired condition, the apparatus preferably has an input unit for setting at least one parameter selected from the cycle, the temperature band, and the variation pattern carried out by the temperature control device.

In addition to the above-described wine storage compartment, a second wine storage compartment for cooling aged wine to an optimal drinking temperature is preferably provided. In this case, the temperature and humidity of the second wine storage compartment can be kept constant by the temperature control device.

Here, since the optimal drinking temperatures of white wine and red wine are slightly different, a white wine storage compartment for storing white wine, and a red wine storage compartment for storing red wine are preferably prepared as the second wine storage compartment to allow the compartments to be cooled by the temperature control device to the temperatures suitable for the white wine and red wine.

### BRIEF DESCRIPTION OF THE DRAWINGS

FIG. 1 is a schematic structural diagram of a wine storage apparatus according to the present invention; and

FIG. 2 is a descriptive diagram showing the temperature variation in an aging wine storage compartment.

### BEST MODE FOR CARRYING OUT THE INVENTION

Described hereinbelow is an embodiment of a wine storage apparatus according to the present invention.

(General Configuration)

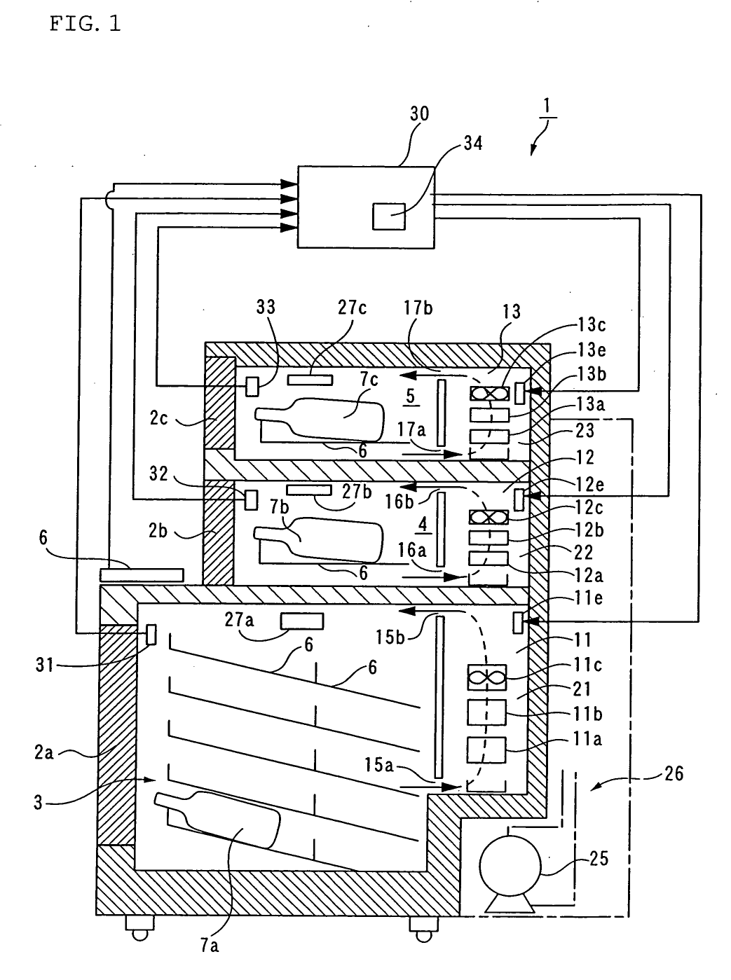

FIG. 1 is a schematic cross-sectional diagram showing a configuration of a wine storage apparatus according to the present invention. A wine storage apparatus 1 has a box-shaped thermally insulated housing 2 in which doors 2a to 2c have been attached to a front side thereof. The interior of the housing 2 is partitioned into three compartments in a vertical direction, and the lowest compartment is a wine aging storage compartment 3, the compartment thereabove is a red wine storage compartment 4, and the highest compartment is a white wine storage compartment 5.

Sliding wine racks 6, for example, are housed in the storage compartments 3 to 5, and a plurality of bottled wines 7a to 7c can be kept in a substantially horizontal orientation on the wine racks 6. It should be noted that the doors 2a to 2c can be independently opened and closed in correspondence with the storage compartments 3 to 5.

A control panel 6 is disposed in the front portion of the housing 2, and the temperature and humidity of each of the storage compartments 3, 4, and 5 can be set and varied thereby. A variation pattern of the compartment temperature, a variation band, and a variation cycle of the wine aging storage compartment 3 can also be set and varied. A display unit for displaying the temperature and humidity of the storage compartments 3 to 5, the temperature and humidity settings, and other information is also disposed on the control panel 6.

The storage compartments 3 to 5 are provided with temperature control mechanisms 11 to 13 for bringing the temperature in each compartment to a predetermined temperature by controlling the temperature of the air that circulates through the compartments. The temperature in the top-tier white wine storage compartment 5 and the mid-tier red wine storage compartment 4 can be selected from temperature settings that range from 5° C. to 20° C., and the white wine or the red wine can be stored at an optimal drinking temperatures thereof. The temperature in the bottom-tier aging storage compartment 3 can be repeatedly raised and lowered in accordance with a preset cycle, a preset temperature band, and a preset variation pattern.

The temperature control mechanisms 11 to 13 are disposed in air-conditioned compartments 21 to 23 partitioned by partitioning plates behind the storage compartments 3 to 5. The temperature control mechanisms 11 to 13 are provided with evaporators (coolers) 11a to 13a for cooling the air taken in from the storage compartments 3 to 5 through intake ports 15a to 17a formed in a lower end position of the partitioning plates, heaters 11b to 13b for heating the air that has passed through the evaporators 11a to 13a, and ventilation fans 11c to 13c whereby the air whose temperature has been controlled by the evaporators 11a to 13a and heaters 11b to 13b is blown to the storage compartments 3 to 5 through blow ports 15b to 17b formed in an upper end of the partitioning plates 15 to 17.

The temperature control mechanisms 11 to 13 are provided with control circuits 11e to 13e, respectively, and are independently controlled. Also, the evaporators (coolers) 11a to 13a are connected to a common refrigerant circuit 26 provided with a common compressor 25 disposed in a lower end portion of the housing 2, a condenser, an expansion valve (not shown), and other components. Control mechanisms that use Peltier elements may naturally be used as the temperature control mechanisms 11 to 13.

Next, humidifiers 27a to 27c are disposed as compartment humidity control devices in the storage compartments 3 to 5. For example, the humidity in the compartments may be kept at about 65%.

The wine storage apparatus 1 of the present embodiment is provided with a control apparatus 30 configured around a microcomputer. The control apparatus 30 controls control circuits 12e and 13e of the temperature control mechanisms 12 and 13 on the basis of detection results of temperature sensors 32 and 33 disposed inside the storage compartments 4 and 5, and keeps the temperature of the storage compartments 4 and 5 at a set level. The control apparatus 30 has a timer function or a calendar function 34, controls control circuit 11e of the temperature control mechanism 11 on the basis of detection results of temperature sensor 31 disposed inside the aging storage compartment 3, and varies the temperature of the storage compartment 3 in accordance with the set variation pattern.

(Temperature Control in the Aging Storage Compartment)

In the aging storage compartment 3 of the wine storage apparatus 1 thus configured, the compartment temperature is controlled by the control apparatus 30 in the manner described below.

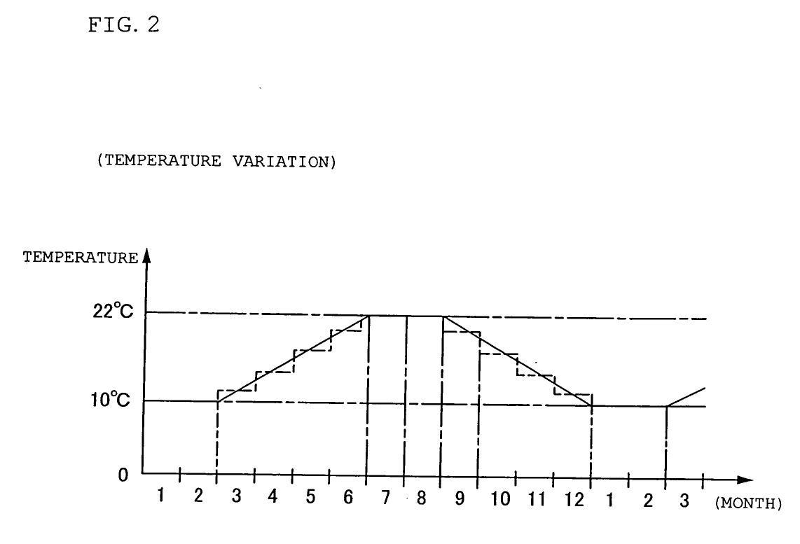

FIG. 2 is a graph showing the temperature variation in the aging storage compartment 3. In the present embodiment, the temperature variation band is set to in a range of 10° C. to 22° C. via an operating unit, and the temperature variation cycle is set to one year. The temperature variation pattern is set so that the temperature is kept at 10° C. for two months of January and February, is increased 3° per month with a fixed gradient between the beginning of March to the last day of June, is kept at 22° C. for two months of July and August, and is reduced 3° per month with a fixed gradient between the beginning of September to the last day of December.

Here, varying the temperature in short cycles should be avoided and should involve at least three cycles per year, with each cycle lasting four months or more. Semiannual or annual cycles may commonly be employed. The temperature band is 12° in the range of 10° to 22° C., but it was confirmed that the wine can be suitably aged when the temperature is varied by the temperature band of 8° or more within this range.

It should be noted that, depending on the type of wine, it is possible to age the wine by varying the temperature in the aging storage compartment 3 by the temperature band of at least 4° within a range of 8° C. to 25° C.

It is also possible to adopt a sinusoidal pattern, for example, as the variation pattern for the compartment temperature. In lieu thereof, it is possible to adopt a pattern wherein the temperature is raised or lowered in a stepwise fashion every month, for example, as shown by the broken line in FIG. 2.

### INDUSTRIAL APPLICABILITY

In the aging storage compartment of the wine storage apparatus of the present invention, the temperature is repeatedly varied according to a fixed cycle, a fixed temperature band, and a fixed variation pattern. It was confirmed that wine can be aged by oxidation in the aging storage compartment by suitably combining these parameters.

In accordance with the present invention, ideal aging is made possible by preserving the wine, which is different from common wine cellars for preserving wine at a constant temperature so as to avoid spoilage. Hence, wine aged in accordance with the preferences of the user can be easily obtained.

1. A wine storage apparatus comprising a wine storage compartment for storing wine, and
a temperature control device for controlling a temperature of the wine storage compartment,
wherein the temperature control device repeatedly raises and lowers the temperature in the compartment in accordance with a preset cycle, a preset temperature band, and a preset variation pattern.

2. The wine storage apparatus according to claim 1, wherein the shortest cycle is four months.

3. The wine storage apparatus according to claim 1, wherein the cycle is one year.

4. The wine storage apparatus according to claim 1, wherein the temperature band is 4° or greater in a range from 8° C. to 25° C.

5. The wine storage apparatus according to claim 4, wherein the temperature band is 8° or greater in a range from 10° C. to 22° C.

6. The wine storage apparatus according to claim 1, wherein the variation pattern is a pattern in which the temperature in the compartment is raised in a linear, curvilinear, or stepwise manner, and is lowered in a linear, curvilinear, or stepwise manner.

7. The wine storage apparatus according to claim 1, comprising a humidity control device for keeping a humidity of the wine storage compartment at a preset value.

8. The wine storage apparatus according to claim 7, wherein the humidity control device keeps the humidity of the wine storage compartment at about 65%.

9. The wine storage apparatus according to claim 1, comprising an input unit for setting at least one setting selected from the cycle, the temperature band, and the variation pattern carried out by the temperature control device.

10. The wine storage apparatus according to claim 1, comprising a second wine storage compartment for storing wine, wherein the temperature control device keeps temperature and humidity of the second wine storage compartment constant.

11. The wine storage apparatus according to claim 1, wherein the second wine storage compartment has a white wine storage compartment for storing white wine and a red wine storage compartment for storing red wine; and
the temperature control device keeps the white wine storage compartment and the red wine storage compartment at different temperatures.

12. The wine storage apparatus according to claim 1, wherein the cycle is six months or one year;
the temperature band is 8° or greater in a range from 10° C. to 22° C.; and
the variation pattern is a pattern in which the temperature in the compartment is raised in a linear, curvilinear, or stepwise manner, and is lowered in a linear, curvilinear, or stepwise manner.

13. The wine storage apparatus according to claim 12, comprising a humidity control device for keeping the humidity of the wine storage compartment at about 65%.

14. The wine storage apparatus according to claim 13, comprising an input unit for setting at least one setting selected from the cycle, the temperature band, and the variation pattern carried out by the temperature control device.

15. The wine storage apparatus according to claim 14, comprising a second wine storage compartment for storing wine, wherein the temperature control device keeps temperature and humidity of the second wine storage compartment constant.

16. The wine storage apparatus according to claim 15, wherein the second wine storage compartment has a white wine storage compartment for storing white wine and a red wine storage compartment for storing red wine; and the temperature control device keeps the white wine storage compartment and the red wine storage compartment at different temperatures.
